(19) United States
(12) Patent Application Publication
(10) Pub. No.: US 2009/0168261 A1
(43) Pub. Date: Jul. 2, 2009

(54) HEAD SLIDER AND MAGNETIC STORAGE DEVICE

(75) Inventors: Sachiko Furuya, Kawasaki (JP); Tetsuyuki Kubota, Kawasaki (JP); Junichi Hashimoto, Kawasaki (JP); Tomoka Aoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/203,601

(22) Filed: Sep. 3, 2008

(30) Foreign Application Priority Data
Dec. 27, 2007 (JP) 2007-338297

(51) Int. Cl. G11B 5/33

(52) U.S. Cl. 360/319; 360/324.2; G9B/5.104

(57) ABSTRACT

A magnetoresistive element is located between a lower shielding layer and an upper shielding layer. The magnetoresistive element receives an electric current through the lower shielding layer and the upper shielding layer. A non-magnetic conductive layer is embedded in the insulating film between the slider body and the lower shielding layer. An air layer is formed between the head slider and a storage medium. Capacitive coupling is established between the head slider and the storage medium. The capacitive coupling allows transmission of the noise from the storage medium to the slider body. The noise affects capacitance established between the lower shielding layer and the slider body. The non-magnetic conductive layer serves to prevent variation in a potential difference resulting from transmission of the noise between the lower shielding layer and the upper shielding layer.

### BACKGROUND OF THE INVENTION

1. Field of the Invention

The present invention relates to a head slider incorporated in a storage device such as a hard disk drive, HDD, for example.

2. Description of the Prior Art

A tunnel-junction magnetoresistive (TMR) element is mounted on a head slider, for example. The TMR element is embedded in an insulating film on the slider body of the head slider. The insulating film is made of Al₂O₃ (alumina) or the like. The TMR element includes a tunnel-junction film located between a lower shielding layer and an upper shielding layer. A sensing current is supplied to the tunnel-junction film through the lower shielding layer and the upper shielding layer.

In the TMR element, the lower shielding layer and the slider body in combination serves as a capacitor. When capacitive coupling is established, for example, a noise is transmitted to the slider body from the magnetic disk over a distance therebetween. An electrical energy stored in the capacitor increases in response to the transmission of the noise. A potential difference is thus generated between the lower shielding layer and the upper shielding layer. Such a potential difference is mixed with the potential difference of a reproduction signal changed in response to the reception of magnetic field. In particular, when a signal having a higher frequency is read out, the noise has a larger influence on the potential difference. The S/N (signal-to-noise) ratio is deteriorated. Magnetic information data cannot be detected with accuracy.

### SUMMARY OF THE INVENTION

It is accordingly an object of the present invention to provide a head slider contributing to an accurate readout of signals having high frequency with a current-perpendicular-to-the-plane (CPP) structure magnetoresistive (MR) element.

According to a first aspect of the present invention, there is provided a head slider comprising: a slider body; a current-perpendicular-to-the-plane (CPP) structure magnetoresistive (MR) element embedded in an insulating film on the slider body, the current-perpendicular-to-the-plane structure magnetoresistive element including a magnetoresistive element located between a lower shielding layer and an upper shielding layer, the magnetoresistive element designed to receive an electric current through the lower shielding layer and the upper shielding layer; and a non-magnetic conductive layer embedded in the insulating film between the slider body and the lower shielding layer.

A so-called sensing current is supplied to the magnetoresistive film through the lower shielding layer and the upper shielding layer for readout of magnetic information data. The head slider is opposed to the surface of a magnetic storage medium at a distance during the supply of the sensing current. A relative movement is induced between the head slider and the magnetic storage medium. An air layer is formed between the head slider and the magnetic storage medium. Capacitive coupling is thus established between the head slider and the magnetic storage medium. Electrical noise is transmitted to the magnetic storage medium. The capacitive coupling allows transmission of the noise from the magnetic storage medium to the slider body over a distance therebetween. The noise affects capacitance established between the lower shielding layer and the slider body. The non-magnetic conductive layer serves to prevent variation in a potential difference resulting from transmission of the noise between the lower shielding layer and the upper shielding layer. Deterioration of the S/N ratio of a reproduction signal can be avoided. Even when a signal having a high frequency is read out, magnetic information data can be detected with accuracy. Moreover, it is possible to maintain the structure or design of the slider body, the lower shielding layer and the upper shielding layer. In other words, the slider body, the lower shielding layer and the upper shielding layer can be spaced from one another as before. The expected magnetic performance is in this manner maintained.

The non-magnetic conductive layer is preferably made of a low thermal expansion material, for example. Even when heat is applied to the non-magnetic conductive layer, the non-magnetic conductive layer is prevented from a thermal expansion. This results in suppression of the amount of protrusion of the magnetoresistive film. Even when an application of heat is utilized to control the amount of protrusion of the current-perpendicular-to-the-plane structure magnetoresistive element, the amount of protrusion of the magnetoresistive film can be controlled with accuracy. The non-magnetic conductive layer may be made of one of SiC, DLC, Mo and W.

The head slider may further comprise: a magnetic pole embedded in the insulating film on the current-perpendicular-to-the-plane structure magnetoresistive element; and an electrically-conductive body electrically connecting the magnetic pole to the slider body, wherein capacitance established between the slider body and the lower shielding layer corresponds to capacitance established between the magnetic pole and the upper shielding layer. The capacitive coupling allows transmission of the noise from the magnetic storage medium to the slider body over a distance therebetween. The noise affects the capacitance established between the lower shielding layer and the slider body. Variation in a potential is thus induced in the lower shielding layer. The noise simultaneously affects the capacitance established between the magnetic pole and the upper shielding layer. Variation in a potential is thus induced in the upper shielding layer. Since the values of the capacitances are set equal to each other, the variation of a potential in the upper shielding layer corresponds to the variation of a potential in the lower shielding layer. No potential difference is thus generated between both the ends of a read element. Generation of a potential difference resulting from transmission of the noise is prevented in a reproduction signal generated in the read element. Deterioration of the S/N ratio of the reproduction signal can be avoided. Even when a signal having a high frequency is read out, magnetic information data can be detected with accuracy. Moreover, it is possible to maintain the structure or design of the slider body, the lower shielding layer, the upper shielding layer and the magnetic pole. In other words, the slider body, the lower shielding layer, the upper shielding layer and the magnetic pole can be spaced from one another as before. The expected magnetic performance can in this manner be maintained.

In the head slider, the slider body may be electrically connected to the non-magnetic conductive layer. The capacitance between the slider body and the lower shielding layer can easily be adjusted by changing the area and the thickness of an insulating layer interposed between the non-magnetic conductive layer and the lower shielding layer. In this manner, the value of the capacitance established between the lower shielding layer and the slider body can be set equal to the value of the capacitance established between the magnetic pole and the upper shielding layer in a relatively facilitated manner. Generation of a potential difference resulting from transmission of the noise can be prevented in a relatively facilitated manner.

According to a second aspect of the present invention, there is provided a head slider comprising: a slider body; a current-perpendicular-to-the-plane (CPP) structure magnetoresistive (MR) element embedded in an insulating film on the slider body, the current-perpendicular-to-the-plane structure magnetoresistive element including a magnetoresistive element located between a lower shielding layer and an upper shielding layer, the magnetoresistive element designed to receive an electric current through the lower shielding layer and the upper shielding layer; a magnetic pole embedded in the insulating film on the current-perpendicular-to-the-plane structure magnetoresistive element; a non-magnetic conductive layer embedded in the insulating film between the upper shielding layer and the magnetic pole; and an electrically-conductive body electrically connecting the magnetic pole to the slider body.

When capacitive coupling is established, a noise is transmitted to the slider body from the magnetic storage medium over a distance therebetween in the same manner as described above. The noise affects the capacitance established between the lower shielding layer and the slider body. The noise simultaneously affects the capacitance established between the magnetic pole and the upper shielding layer. The conductive layer serves to prevent variation in a potential difference resulting from transmission of the noise between the lower shielding layer and the upper shielding layer. Deterioration of the S/N ratio of a reproduction signal can be avoided. Even when a signal having a high frequency is read out, magnetic information data can be detected with accuracy. Moreover, it is possible to maintain the structure or design of the slider body, the lower shielding layer and the upper shielding layer. In other words, the slider body, the lower shielding layer and the upper shielding layer can be spaced from one another as before. The expected magnetic performance can in this manner be maintained.

Here, the non-magnetic conductive layer is preferably made of a low thermal expansion material, for example. Even when heat is applied to the non-magnetic conductive layer, the thermal expansion of the non-magnetic conductive layer is suppressed. This results in suppression of the amount of protrusion of the magnetoresistive film. Even when an application of heat is utilized to control the amount of protrusion of the current-perpendicular-to-the-plane structure magnetoresistive element, the amount of protrusion of the magnetoresistive film is controlled with accuracy. The non-magnetic conductive layer may be made of one of SiC, DLC, Mo and W.

The capacitance established between the upper shielding layer and the magnetic pole preferably corresponds to the capacitance established between the slider body and the lower shielding layer. The capacitive coupling allows transmission of the noise from the magnetic storage medium to the slider body over a distance therebetween. The noise affects the capacitance established between the lower shielding layer and the slider body. Variation in a potential is thus induced in the lower shielding layer. The noise simultaneously affects the capacitance established between the magnetic pole and the upper shielding layer. Variation in a potential is thus induced in the upper shielding layer. Since the values of the capacitances are set equal to each other, the variation of a potential in the upper shielding layer corresponds to the variation of a potential in the lower shielding layer. No potential difference is thus generated between both the ends of a read element. Generation of a potential difference resulting from transmission of the noise is prevented in a reproduction signal generated in the read element. Deterioration of the S/N ratio of the reproduction signal can be avoided. Even when a signal having a high frequency is read out, magnetic information data can be detected with accuracy as usual. Moreover, it is possible to maintain the structure or design of the slider body, the lower shielding layer, the upper shielding layer and the magnetic pole. In other words, the slider body, the lower shielding layer, the upper shielding layer and the magnetic pole can be spaced from one another as before. The expected magnetic performance can in this manner be maintained.

In the head slider, the non-magnetic conductive layer may be electrically connected to the magnetic pole. The capacitance established between the magnetic pole and the upper shielding layer can easily be adjusted by changing the area and the thickness of an insulating layer interposed between the non-magnetic conductive layer and the upper shielding layer. The value of the capacitance between the magnetic pole and the upper shielding layer can thus be set equal to the value of the capacitance between the lower shielding layer and the slider body in a relatively facilitated manner. Generation of a potential difference resulting from transmission of the noise can be prevented in a relatively facilitated manner.

The head slider is incorporated in a magnetic storage device such a hard disk drive, HDD, for example. It should be noted that the head slider can be utilized in any device other than a magnetic storage device.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating a hard disk drive as a specific example of a magnetic storage device;

FIG. 2 is an enlarged perspective view schematically illustrating a flying head slider according to a first embodiment of the present invention;

FIG. 3 is an enlarged perspective view schematically illustrating an electromagnetic transducer mounted on the flying head slider;

FIG. 4 is a front view schematically illustrating the surface of a head protection film observed downstream of an air bearing surface;

FIG. 5 is a sectional view taken along the line 5-5 in FIG. 4;

FIG. 6 is a view schematically illustrating a circuitry established in the flying head slider according to the first embodiment of the present invention;

FIG. 7 is a graph showing the frequency characteristics of noise levels;

FIG. 8 is a view schematically illustrating a circuitry established in a flying head slider according to a second embodiment of the present invention;

FIG. 9 is a view schematically illustrating a circuitry established in a flying head slider according to a third embodiment of the present invention; and

FIG. 10 is a view schematically illustrating a circuitry established in a flying head slider according to a fourth embodiment of the present invention.

### DESCRIPTION OF THE PREFERRED EMBODIMENTS

FIG. 1 schematically illustrates the inner structure of a hard disk drive, HDD, 11 as an example of a storage medium drive or storage device. The hard disk drive 11 includes a box-shaped enclosure 12. The enclosure 12 includes an enclosure cover, not shown, and a boxed-shaped enclosure base 13 defining an inner space of a flat parallelepiped, for example. The enclosure base 13 may be made of a metallic material such as aluminum, for example. Molding process may be employed to form the enclosure base 13. The enclosure cover is coupled to the enclosure base 13. The enclosure cover serves to close the opening of the inner space within the enclosure base 13. Pressing process may be employed to form the enclosure cover out of a plate material, for example.

At least one magnetic recording disk 14 as a recording medium is placed within the inner space of the enclosure base 13. The magnetic recording disk or disks 14 is mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rpm, or the like. Here, a so-called perpendicular magnetic recording disk is employed as the magnetic recording disk or disks 14, for example. Specifically, the axis of easy magnetization is aligned in the vertical direction perpendicular to the surface of the magnetic recording disk 14 in a magnetic recording layer on the magnetic recording disk 14.

A carriage 16 is also placed within the inner space of the enclosure base 13. The carriage 16 includes a carriage block 17. The carriage block 17 is supported on a vertical support shaft 18 for relative rotation. Carriage arms 19 are defined in the carriage block 17. The carriage arms 19 are designed to extend in a horizontal direction from the vertical support shaft 18. The carriage block 17 may be made of aluminum, for example. Extrusion process may be employed to form the carriage block 17, for example.

A head suspension 21 is attached to the front or tip end of the individual carriage arm 19. The head suspension 21 is designed to extend forward from the carriage arm 19. A flexure is attached to the head suspension 21. The flexure defines a so-called gimbal at the front or tip end of the head suspension 21. A magnetic head slider or flying head slider 22 is supported on the gimbal. The gimbal allows the flying head slider 22 to change its attitude relative to the head suspension 21. A head element or electromagnetic transducer is mounted on the flying head slider 22.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

A power source such as a voice coil motor, VCM, 23 is coupled to the carriage block 17. The voice coil motor 23 serves to drive the carriage block 17 around the vertical support shaft 18. The rotation of the carriage block 17 allows the carriage arms 19 and the head suspensions 21 to swing. When the individual carriage arm 19 swings around the vertical support shaft 18 during the flight of the flying head slider 22, the flying head slider 22 is allowed to move along the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

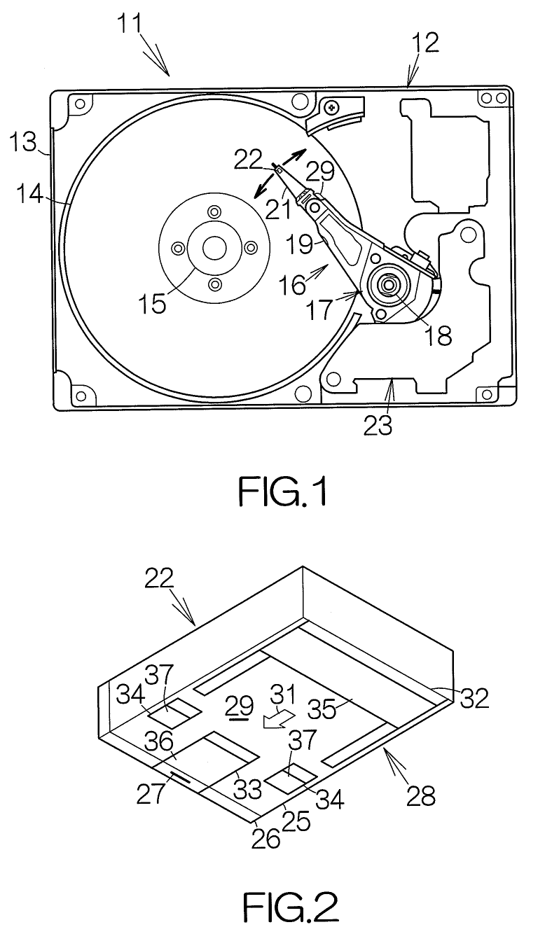

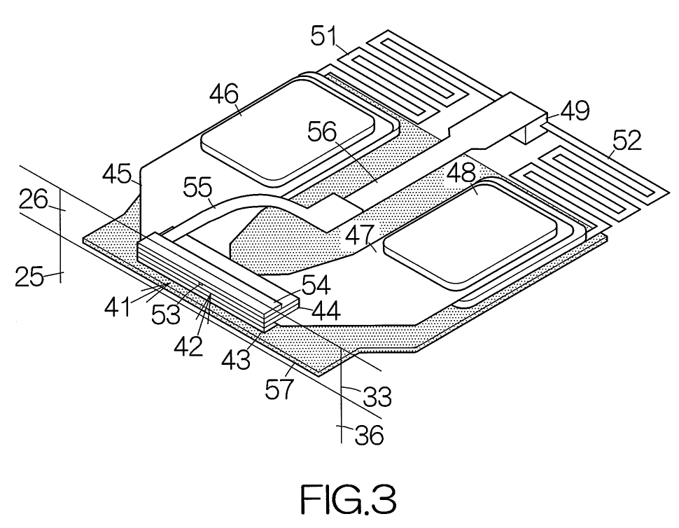

FIG. 2 illustrates a specific example of the flying head slider 22 according to a first embodiment of the present invention. The flying head slider 22 includes a slider body 25 in the form of a flat parallelepiped, for example. An insulating non-magnetic film, namely a head protection film 26, is overlaid on the outflow or trailing end surface of the slider body 25. An electromagnetic transducer 27 is incorporated in the head protection film 26. Description will be made on the electromagnetic transducer 27 later in detail.

The slider body 25 may be made of a hard material such as Al₂O₃—TiC performing as a non-magnetic conductor. The head protection film 26 is made of a soft material such as Al₂O₃ (alumina) performing as a non-magnetic insulator. A medium-opposed surface or bottom surface 28 is defined over the slider body 25 so as to face the magnetic recording disk 14 at a distance. A flat base surface 29 as a reference surface is defined on the bottom surface 28. When the magnetic recording disk 14 rotates, airflow 31 flows along the bottom surface 28 from the inflow or front end toward the outflow or rear end of the slider body 25.

A front rail 32 is formed on the bottom surface 28 of the slider body 25. The front rail 32 stands upright from the base surface 29 near the inflow end of the slider body 25. The front rail 32 extends along the inflow end of the base surface 29 in the lateral direction of the slider body 25. A rear center rail 33 is likewise formed on the bottom surface 28 of the slider body 25. The rear center rail 33 stands upright from the base surface 29 near the outflow end of the slider body 25. The rear center rail 33 is located at the intermediate position in the lateral direction of the slider body 25. The rear center rail 33 is designed to extend to the head protection film 26. A pair of rear side rails 34, 34 is likewise formed on the bottom surface 28 of the slider body 25. The rear side rails 34, 34 stand upright from the base surface 29 of the bottom surface 28 near the outflow end of the slider body 25. The rear side rails 34, 34 are located along the sides of the slider body 25, respectively. The rear side rails 34, 34 are thus distanced from each other in the lateral direction of the slider body 25. The rear center rail 33 is located in a space between the rear side rails 34, 34.

Air bearing surfaces 35, 36, 37 are defined on the top surfaces of the rails 32, 33, 34, respectively. Steps connect the inflow ends of the air bearing surfaces 35, 36, 37 to the top surfaces of the rails 32, 33, 34, respectively. The bottom surface 28 of the flying head slider 22 is designed to receive the airflow 31 generated along the rotating magnetic recording disk 14. The steps serve to generate a larger positive pressure or lift at the air bearing surfaces 35, 36, 37, respectively. Moreover, a larger negative pressure is generated behind the front rail 32 or at a position downstream of the front rail 32. The negative pressure is balanced with the lift so as to stably establish the flying attitude of the flying head slider 22. It should be noted that the flying head slider 22 can take any shape or form different from the described one.

The electromagnetic transducer 27 is embedded in the rear center rail 33 at a position near the outflow end of the air bearing surface 36. As shown in FIG. 3, the electromagnetic transducer 27 includes a read element 41 and a write element 42. A tunnel-junction magnetoresistive (TMR) element is employed as the read element 41. The TMR element is allowed to induce variation in the electric resistance of the tunnel-junction film in response to the inversion of polarization in the applied magnetic field leaked from the magnetic recording disk 14. This variation in the electric resistance is utilized to detect binary data recorded on the magnetic recording disk 14. A so-called single-pole head is employed as the write element 42. The single-pole head generates a magnetic with the assistance of a thin film coil pattern. The generated magnetic field is utilized to record binary data into the magnetic recording disk 14. The electromagnetic transducer 27 allows the read gap of the read element 41 and the write gap of the write element 42 to get exposed at the surface of the head protection film 26. A hard protection film may be formed on the surface of the head protection film 26 at a position near the outflow end of the air bearing surface 36. Such a protection film covers over the tip ends of the write gap and read gap exposed at the surface of the head protection film 26. The protection film may be made of a diamond like carbon film, for example.

The TMR element or read element 41 includes a magnetoresistive film, namely the tunnel-junction film interposed between a lower shielding layer 32 and an upper shielding layer 44. The lower and upper shielding layers 43, 44 are made of an electrically-conductive magnetic material such as FeN, NiFe or the like. The lower and upper shielding layers 43, 44 function as the upper and lower electrodes of the read element 41, respectively, as described later.

A lead 45 is connected to the upper shielding layer 44 at a position between the lower shielding layer 43 and the upper shielding layer 44. A connecting pad 46 made of an electrically-conductive material is overlaid on the lead 45. A terminal pad, not shown, is connected to the connecting pad 46. The terminal pad is exposed at the surface of the head protection film 26 near the outflow end of the slider body 25. A wiring pattern formed on the flexure is connected to the terminal pad. An electrically-conductive ball, solder or the like is utilized to connect the wiring pattern. The lead 45, the connecting pad 46 and the terminal pad are made of an electrically-conductive material such as copper, for example.

Likewise, a lead 47 is connected to the lower shielding layer 43 at a position between the lower shielding layer 43 and the upper shielding layer 44. A connecting pad 48 made of an electrically-conductive material is overlaid on the lead 47. A terminal pad, not shown, is connected to the connecting pad 48. The terminal pad is exposed at the surface of the head protection film 26 near the outflow end of the slider body 25. The wiring pattern formed on the flexure is connected to the terminal pad. An electrically-conductive ball, solder or the like is utilized to connect the wiring pattern. The lead 47, the connecting pad 48 and the terminal pad are made of an electrically-conductive material such as copper, for example.

The leads 45, 47 are electrically connected to the slider body 25. In this case, the leads 45, 47 are separately connected to an electrically-conductive piece 49. The electrically-conductive piece 49 contacts with the slider body 25. The lower shielding layer 43 and the upper shielding layer 44 are in this manner grounded to the slider body 25. Narrow current paths or wiring patterns 51, 52 connect the leads 45, 47 to the electrically-conductive piece 49, respectively. The wiring patterns 51, 52 function as a shunt resistance.

The single-pole head or write head 42 includes a main magnetic pole 53 as a lower magnetic pole and an auxiliary magnetic pole 54 as an upper magnetic pole. The auxiliary magnetic pole 54 is formed above the main magnetic pole 53. The main magnetic pole 53 and the auxiliary magnetic pole 54 are made of an electrically-magnetic material such as FeN, NiFe or the like. The main magnetic pole 53 and the auxiliary magnetic pole 54 are magnetically connected to each other as described later. A pair of terminal pads, not shown, is connected to the thin film coil pattern. The terminal pads are exposed at the surface of the head protection film 26 near the outflow end of the slider body 25. The wiring pattern formed on the flexure is connected to the terminal pads. An electrically-conductive ball, solder or the like is utilized to connect the wiring pattern. The terminal pads are also made of an electrically-conductive material such as copper, for example.

The main magnetic pole 53 is electrically connected to the slider body 25. In this case, the main magnetic pole 53 is likewise connected to the aforementioned electrically-conductive piece 49. The main magnetic pole 53 and the electrically-conductive piece 49 are connected to each other through connecting patterns 55, 56. The main magnetic pole 53 and the auxiliary magnetic pole 54 are in this manner grounded to the slider body 25. The connecting patterns 55, 56 are made of an electrically-conductive material such as copper, for example.

A non-magnetic conductive layer 57 is embedded in the head protection film 26 at a position between the lower shielding layer 43 and the slider body 25. The head protection film 26 serves to insulate the non-magnetic conductive layer 57 from the lower shielding layer 43 and the slider body 25. The non-magnetic conductive layer 57 is made of a low thermal expansion material, for example. One of SiC, DLC, Mo and W may be employed as the low thermal expansion material, for example.

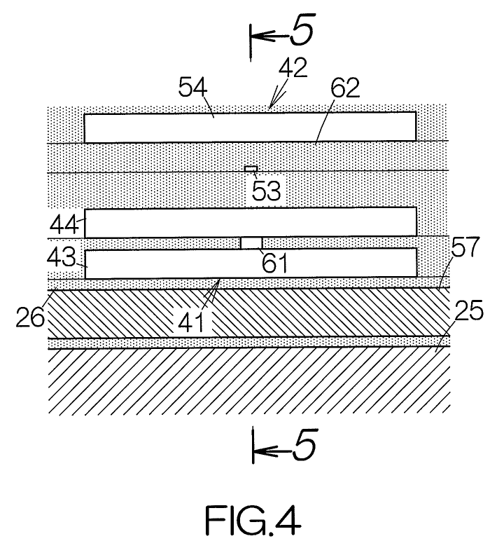

FIG. 4 illustrates the surface of the head protection film 26 downstream of the air bearing surface 36. As shown in FIG. 4, the front ends of the lower and upper shielding layers 43, 44 of the read element 41 are exposed at the surface of the head protection film 26. A tunnel-junction film 61 is interposed between the lower shielding layer 43 and the upper shielding layer 44 along the surface of the head protection film 26. The front end of the tunnel-junction film 61 is exposed at the surface of the head protection film 26. The lower and upper shielding layers 43, 44 extend backward from the front ends thereof along an imaginary plane perpendicular to the surface of the head protection film 26, namely an imaginary plane parallel to the surface of the outflow end of the slider body 25. A gap between the lower and upper shielding layers 43, 44 determines a linear resolution of magnetic recordation on the magnetic recording disk 14 along the recording track. The upper shielding layer 44 and the lower shielding layer 43 are electrically connected to each other through the tunnel-junction film 61. A sensing current runs through the tunnel-junction film 61 from the upper shielding layer 44 to the lower shielding layer 43. It should be noted that a so-called current-perpendicular-to-the-plane (CPP) structure giant magnetoresistive (GMR) element may be employed as the read element 41 in place of the TMR element. A spin valve film may be employed as a magnetoresistive film in the CPP structure GMR element.

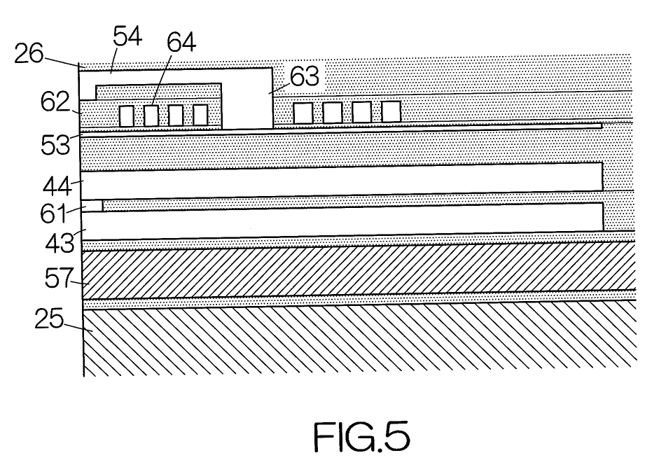

The front ends of the main magnetic pole 53 and the auxiliary magnetic pole 54 of the write element 42 are exposed at the surface of the head protection film 26. The auxiliary magnetic pole 54 extends along the surface of the head protection film 26, for example. An insulating layer 62 is interposed between the auxiliary magnetic pole 54 and the main magnetic pole 53. As is apparent from FIG. 5, the rear end of the auxiliary magnetic pole 54 is connected to the main magnetic pole 53 through a magnetic connecting piece 63. A magnetic coil or thin film coil pattern 64 is formed in a swirly pattern around the magnetic connecting piece 63. The main magnetic pole 53, the auxiliary magnetic pole 54 and the magnetic connecting piece 63 in combination serve as a magnetic core penetrating through the center of the thin film coil pattern 64.

FIG. 6 schematically illustrates a circuitry established in the flying head slider 22. A first capacitor 66 of a capacitance C₁ is established between the main magnetic pole 53 as the lower magnetic pole and the upper shielding layer 44 in the flying head slider 22. A second capacitor 67 of a capacitance C₂ is established between the lower shielding layer 43 and the non-magnetic conductive layer 57. A third capacitor 68 of a capacitance C₃ is established between the non-magnetic conductive layer 57 and the slider body 25. The composite capacitance C of the capacitances C₂, C₃ is designed to correspond to the capacitance C₁. In other words, the value of the composite capacitance C is set equal to that of the capacitance C₁. The composite capacitance C of the capacitances C₂, C₃ can be adjusted by changing the area and the thickness of the non-magnetic conductive layer 57.

Now, assume that magnetic information data is to be read out of the magnetic recording disk 14. A sensing current is supplied to the read element 41 for readout of the information data. The sensing current runs through the lead 45, the upper shielding layer 44, the tunnel-junction film 61, the lower shielding layer 43 and the lead 47 in this sequence. Variation is induced in the electric resistance of the tunnel-junction film 61 in response to the inversion of polarization in a magnetic field leaking from the magnetic recording disk 14. The variation in the electric resistance results in a variation in the potential difference of a reproduction signal extracted from the sensing current. The variation in the potential difference is utilized to detect binary data or magnetic information data recorded in the magnetic recording disk 14.

The flying head slider 22 is opposed to the surface of the rotating magnetic recording disk 14 at a distance for readout of magnetic information data. An air layer is formed between the flying head slider 22 and the magnetic recording disk 14. Capacitive coupling is thus established between the flying head slider 22 and the magnetic recording disk 14. An electrical noise 69 is transmitted to the magnetic recording disk 14 from the spindle motor 15 and a printed circuit board. The capacitive coupling induces transmission of the noise 69 from the magnetic recording disk 14 to the slider body 25 over a distance therebetween. The noise 69 affects the capacitances C₂, C₃ of the capacitors 67, 68. Variation in the potential R− of the reproduction signal is thus induced in the lower shielding layer 43. In this case, since the main magnetic pole 53 is connected to the slider body 25 through the connecting patterns 55, 56, the noise 69 simultaneously affects the capacitance C₁ of the capacitor 66. Variation in the potential R+ of the reproduction signal is thus induced in the upper shielding layer 44. Since the value of the capacitance C₁ is set equal to that of the composite capacitance C of the capacitances C₂, C₃, the variation in the potential R+ in the upper shielding layer 44 coincides with the variation in the potential R− in the lower shielding layer 43. No potential difference is thus generated in the reproduction signal in response to transmission of the noise 69. Deterioration of the S/N ratio of the reproduction signal can be avoided. Even when a signal having a high frequency is read out, magnetic information data can be detected with accuracy. Moreover, it is possible to maintain the structure or design of the slider body 25, the lower shielding layer 43, the upper shielding layer 44, the main magnetic pole 53 and the auxiliary magnetic pole 54. In other words, the slider body 25, the lower shielding layer 43, the upper shielding layer 44, the main magnetic pole 53 and the auxiliary magnetic pole 54 can be spaced from one another as before. The expected magnetic performance can in this manner be maintained.

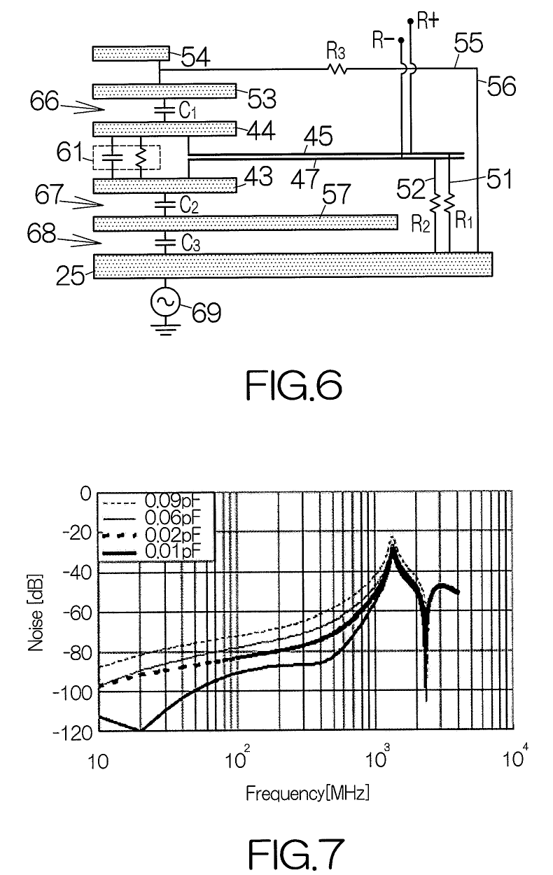

The inventors have observed a correlation between a noise and a difference between the capacitance C₁ and the composite capacitance C. A computer simulation was utilized for the observation. A difference between the capacitance C₁ and the composite capacitance C was set at 0.01 [pF], 0.02 [pF], 0.06 [pF] and 0.09 [pF]. A noise of 1[V] was input into the flying head slider 22. The amount of a noise detected from the leads 45, 47 was calculated in response thereto. As shown in FIG. 7, it has been revealed that a reduction in the difference in capacitance results in a reduction in the amount of the noise.

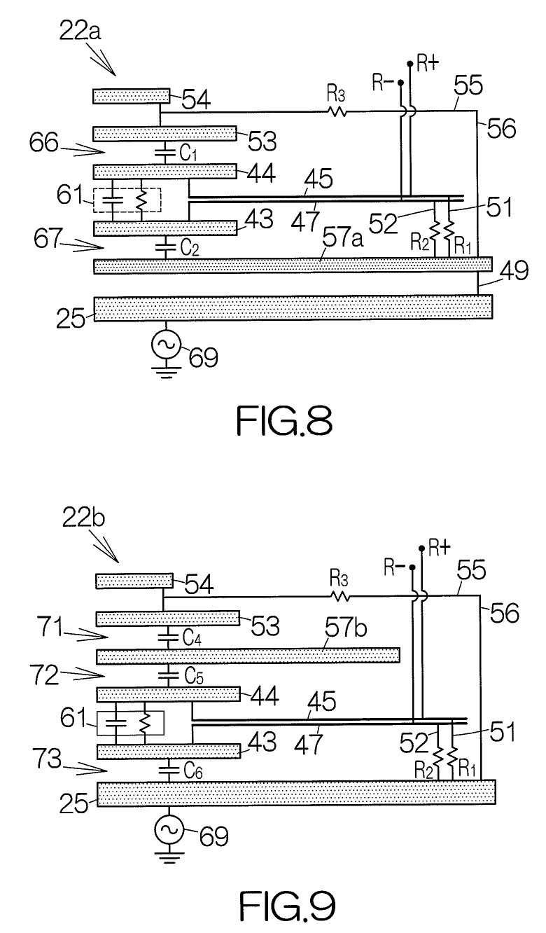

FIG. 8 schematically illustrates a circuitry established in a flying head slider 22a according to a second embodiment of the present invention. A non-magnetic conductive layer 57a, corresponding to the non-magnetic conductive layer 57 of the first embodiment, is electrically connected to the slider body 25 in the flying head slider 22a. The non-magnetic conductive layer 57a has a structure identical to that of the non-magnetic conductive layer 57. The non-magnetic conductive layer 57a may be connected to the aforementioned electrically-conductive piece 49 for the electrical connection to the slider body 25. The capacitance C₂ is designed to correspond to the capacitance C₁ in the flying head slider 22a. In other words, the value of the capacitance C₂ is set equal to that of the capacitance C₁. The capacitance C₂ can be adjusted by changing the area and the thickness of the non-magnetic conductive layer 57a. Like reference numerals are attached to the structure or components equivalent to those of the aforementioned flying head slider 22.

The capacitive coupling allows transmission of the noise 69 from the magnetic recording disk 14 to the slider body 25 over a distance therebetween. The noise 69 affects the capacitance C₂ of the capacitor 67. Variation in the potential R− of the sensing current is thus induced in the lower shielding layer 43. Since the main magnetic pole 53 is connected to the slider body 25 through the connecting patterns 55, 56, the noise 69 simultaneously affects the capacitance C₁ of the capacitor 66. Variation in the potential R+ of the sensing current is thus induced in the upper shielding layer 44. Since the value of the capacitance C₁ is set equal to that of the capacitance C₂, the variation in the potential R+ in the upper shielding layer 44 coincides with the variation in the potential R− in the lower shielding layer 43. No potential difference is thus generated in the sensing current in response to transmission of the noise 69. Deterioration of the S/N ratio of the sensing current can be avoided. Even when a signal having a high frequency is read out, magnetic information data can be detected with accuracy. Moreover, it is possible to maintain the structure or design of the slider body 25, the lower shielding layer 43, the upper shielding layer 44, the main magnetic pole 53 and the auxiliary magnetic pole 54. In other words, the slider body 25, the lower shielding layer 43, the upper shielding layer 44, the main magnetic pole 53 and the auxiliary magnetic pole 54 can be spaced from one another as before. The expected magnetic performance can in this manner be maintained.

FIG. 9 schematically illustrates a circuitry established in a flying head slider 22b according to a third embodiment of the present invention. A non-magnetic conductive layer 57b is embedded in the head protection film 26 between the main magnetic pole 53 and the upper shielding layer 44. The head protection film 26 serves to insulate the non-magnetic conductive layer 57b from the main magnetic pole 53 and the upper shielding layer 44. The non-magnetic conductive layer 57b has a structure identical to that of the aforementioned non-magnetic conductive layer 57. Like reference numerals are attached to the structure or components equivalent to those of the aforementioned flying head slider 22.

A first capacitor 71 of a capacitance C₄ is established between the main magnetic pole 53 as the lower magnetic pole and the non-magnetic conductive layer 57b in the flying head slider 22b. A second capacitor 72 of a capacitance C₅ is established between the non-magnetic conductive layer 57b and the upper shielding layer 44. A third capacitor 73 of a capacitance C₆ is established between the lower shielding layer 43 and the slider body 25. The composite capacitance C of the capacitances C₄, C₅ is designed to correspond to the capacitance C₆. In other words, the value of the composite capacitance C is set equal to that of the capacitance C₆. The composite capacitance C of the capacitances C₄, C₅ can be adjusted by changing the area and the thickness of the non-magnetic conductive layer 57b.

The capacitive coupling allows transmission of the noise 69 from the magnetic recording disk 14 to the slider body 25 over a distance therebetween. The noise 69 affects the capacitance C₆ of the capacitor 73. Variation in the potential R− of the reproduction signal is thus induced in the lower shielding layer 43. Since the main magnetic pole 53 is connected to the slider body 25 through the connecting patterns 55, 56, the noise 69 simultaneously affects the capacitances C₄, C₅ of the capacitors 71, 72. Variation in the potential R+ of the reproduction signal is thus induced in the upper shielding layer 44. Since the value of the composite capacitance C of the capacitances C₄, C₅ is set equal to that of the capacitance C₆, the variation in the potential R+ in the upper shielding layer 44 coincides with the variation in the potential R− in the lower shielding layer 43. No potential difference is thus generated in the reproduction signal in response to transmission of the noise 69. Deterioration of the S/N ratio of the reproduction signal can be avoided. Even when a signal having a high frequency is read out, magnetic information data can be detected with accuracy. Moreover, it is possible to maintain the structure or design of the slider body 25, the lower shielding layer 43, the upper shielding layer 44, the main magnetic pole 53 and the auxiliary magnetic pole 54. In other words, the slider body 25, the lower shielding layer 43, the upper shielding layer 44, the main magnetic pole 53 and the auxiliary magnetic pole 54 can be spaced from one another as before. The expected magnetic performance can in this manner be maintained.

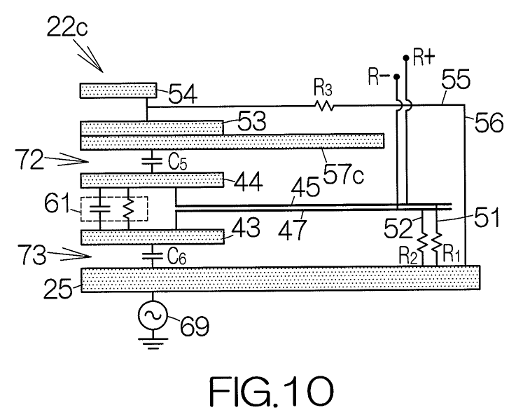

FIG. 10 schematically illustrates a circuitry established in a flying head slider 22c according to a fourth embodiment of the present invention. A non-magnetic conductive layer 57c, corresponding to the non-magnetic conductive layer 57b of the third embodiment, is electrically connected to the main magnetic pole 53 in the flying head slider 22c. The non-magnetic conductive layer 57c has a structure identical to that of the non-magnetic conductive layer 57b. The main magnetic pole 53 may be overlaid on the surface of the non-magnetic conductive layer 57c so that the non-magnetic conductive layer 57c is electrically connected to the main magnetic pole 53. The capacitance C₅ is designed to correspond to the capacitance C₆ in the flying head slider 22c. In other words, the value of the capacitance C₅ is set equal to that of the capacitance C₆. The capacitance C₅ can be adjusted by changing the area and the thickness of the non-magnetic conductive layer 57c. Like reference numerals are attached to the structure or components equivalent to those of the aforementioned flying head slider 22b.

The capacitive coupling allows transmission of the noise 69 from the magnetic recording disk 14 to the slider body 25 over a distance therebetween. The noise 69 affects the capacitance C₆ of the capacitor 73. Variation in the potential R− of the sensing current is thus induced in the lower shielding layer 43. Since the main magnetic pole 53 is connected to the slider body 25 through the connecting patterns 55, 56, the noise 69 simultaneously affects the capacitance C₅ of the capacitor 72. Variation in the potential R+ of the sensing current is thus induced in the upper shielding layer 44. Since the value of the capacitance C₅ is set equal to that of the capacitance C₆, the variation in the potential R+ in the upper shielding layer 44 coincides with the variation in the potential R− in the lower shielding layer 43. No potential difference is thus generated in the sensing current in response to transmission of the noise 69. Deterioration of the S/N ratio of the sensing current can be avoided. Even when a signal having a high frequency is read out, magnetic information data can be detected with accuracy as usual. Moreover, it is possible to maintain the structure or design of the slider body 25, the lower shielding layer 43, the upper shielding layer 44, the main magnetic pole 53 and the auxiliary magnetic pole 54. In other words, the slider body 25, the lower shielding layer 43, the upper shielding layer 44, the main magnetic pole 53 and the auxiliary magnetic pole 54 can be spaced from one another as before. The expected magnetic performance can in this manner be maintained.

In the flying head sliders 22, 22a, 22b, 22c, an auxiliary magnetic pole may be located as the lower magnetic pole in place of the aforementioned main magnetic pole 53 while a main magnetic pole may be located as the upper magnetic pole in place of the aforementioned auxiliary magnetic pole 54. The aforementioned flying head sliders 22, 22a, 22b, 22c may also be utilized for realization of a so-called in-plane magnetic recording. In this case, a thin film magnetic head may be employed in place of the aforementioned single-pole head.

What is claimed is:

1. A head slider comprising:
a slider body;
a current-perpendicular-to-the-plane structure magnetoresistive element embedded in an insulating film on the slider body, the current-perpendicular-to-the-plane structure magnetoresistive element including a magnetoresistive element located between a lower shielding layer and an upper shielding layer, the magnetoresistive element designed to receive an electric current through the lower shielding layer and the upper shielding layer; and
a non-magnetic conductive layer embedded in the insulating film between the slider body and the lower shielding layer.

2. The head slider according to claim 1, wherein the non-magnetic conductive layer is made of a low thermal expansion material.

3. The head slider according to claim 2, wherein the non-magnetic conductive layer is made of one of SiC, DLC, Mo and W.

4. The head slider according to claim 1, further comprising:
a magnetic pole embedded in the insulating film on the current-perpendicular-to-the-plane structure magnetoresistive element; and
an electrically-conductive body electrically connecting the magnetic pole to the slider body, wherein
capacitance established between the slider body and the lower shielding layer corresponds to capacitance established between the magnetic pole and the upper shielding layer.

5. The head slider according to claim 1, wherein the slider body is electrically connected to the non-magnetic conductive layer.

6. A magnetic storage device including the head slider according to claim 1.

7. A head slider comprising:
a slider body;
a current-perpendicular-to-the-plane structure magnetoresistive element embedded in an insulating film on the slider body, the current-perpendicular-to-the-plane structure magnetoresistive element including a magnetoresistive element located between a lower shielding layer and an upper shielding layer, the magnetoresistive element designed to receive an electric current through the lower shielding layer and the upper shielding layer;
a magnetic pole embedded in the insulating film on the current-perpendicular-to-the-plane structure magnetoresistive element;
a non-magnetic conductive layer embedded in the insulating film between the upper shielding layer and the magnetic pole; and
an electrically-conductive body electrically connecting the magnetic pole to the slider body.

8. The head slider according to claim 7, wherein capacitance established between the upper shielding layer and the magnetic pole corresponds to capacitance established between the slider body and the lower shielding layer.

9. The head slider according to claim 7, wherein the non-magnetic conductive layer is electrically connected to the magnetic pole.

10. A magnetic storage device including the head slider according to claim 7.
